(19) United States
(12) Patent Application Publication
(10) Pub. No.: US 2026/0025206 A1
(43) Pub. Date: Jan. 22, 2026

(54) OPTICAL TRANSMISSION APPARATUS, OPTICAL TRANSMISSION SYSTEM, AND OPTICAL TRANSMISSION METHOD

(71) Applicant: Fujitsu Limited, Kawasaki-shi (JP)

(72) Inventor: Hiroshi NAKAMOTO, Kawasaki (JP)

(73) Assignee: Fujitsu Limited, Kawasaki-shi (JP)

(21) Appl. No.: 19/251,145

(22) Filed: Jun. 26, 2025

(30) Foreign Application Priority Data
Jul. 17, 2024 (JP) 2024-114041

(51) Int. Cl. H04B 10/25; H04B 10/291; H04B 10/297; H04B 10/40

(52) U.S. Cl. CPC H04B 10/2589; H04B 10/2916; H04B 10/2972; H04B 10/40

(57) ABSTRACT

An optical transmission apparatus is disposed at an end of a single-core optical fiber and is used when signal light is transmitted bidirectionally by the optical fiber. The optical transmission apparatus includes an optical transmitter that transmits a first signal light in one direction belonging to the signal light, an optical receiver that receives a second signal light in an opposite direction belonging to the signal light, an optical circulator that guides the first signal light transmitted from the optical transmitter to the optical fiber and guides the second signal light from the optical fiber to the optical receiver, and a light source that outputs, to the optical fiber, pump light for Raman-amplifying the second signal light to a second optical power higher than a first optical power of the first signal light.

### CROSS-REFERENCE TO RELATED APPLICATION

This application is based upon and claims the benefit of priority of Japanese Patent Application No. 2024-114041 filed on Jul. 17, 2024, the entire contents of which are incorporated herein by reference.

### FIELD

A certain aspect of the present embodiments relates to an optical transmission apparatus, an optical transmission system, and an optical transmission method.

### BACKGROUND

There has been known a wave-length-division multiplexing (WDM) system using both a forward-pumped Raman fiber amplifier and a backward-pumped Raman fiber amplifier (see, for example, U.S. Laid-Open Patent Publication No. 2007/0058242). There has been also known a multi-band WDM system using a large number of bands (see, for example, U.S. Pat. No. 6,359,725).

### SUMMARY

According to an aspect of the present disclosure, there is provided an optical transmission apparatus that is disposed at an end of a single-core optical fiber and is used when signal light is transmitted bidirectionally by the optical fiber. The optical transmission apparatus includes: an optical transmitter that transmits a first signal light in one direction belonging to the signal light; an optical receiver that receives a second signal light in an opposite direction belonging to the signal light; an optical circulator that guides the first signal light transmitted from the optical transmitter to the optical fiber and guides the second signal light from the optical fiber to the optical receiver; and a light source that outputs, to the optical fiber, pump light for Raman-amplifying the second signal light to a second optical power higher than a first optical power of the first signal light.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF THE DRAWINGS

FIG. 1 illustrates an example of an optical transmission system according to a first embodiment.

FIG. 2 is a block diagram illustrating an example of an optical transmission apparatus according to the first embodiment.

FIG. 3 is a diagram illustrating a comparative example.

FIG. 4 is a diagram illustrating Example 1.

FIG. 5 is a block diagram illustrating an example of an optical transmission apparatus according to a second embodiment.

FIG. 6 illustrates an example of an optical transmission system according to a third embodiment.

FIG. 7 is a block diagram illustrating an optical transmission apparatus according to a third embodiment.

FIG. 8 is a block diagram illustrating an example of an optical repeater according to the third embodiment.

FIG. 9 is a block diagram illustrating an example of an optical transmission apparatus according to a fourth embodiment.

FIG. 10 is a block diagram illustrating an example of an optical repeater according to the fourth embodiment.

FIG. 11 is a diagram illustrating Example 2.

FIG. 12 is a block diagram illustrating an example of an optical transmission apparatus according to a fifth embodiment.

FIG. 13 is a block diagram illustrating an example of an optical transmission apparatus according to a sixth embodiment.

FIG. 14A is a block diagram illustrating an example of an optical repeater according to the sixth embodiment.

FIG. 14B is a block diagram illustrating another example of an optical repeater according to the sixth embodiment.

FIG. 15 is a flowchart illustrating an example of an operation of a control unit.

FIG. 16 is a block diagram illustrating an example of an optical transmission apparatus according to a seventh embodiment.

FIG. 17 is a block diagram of an optical transmission apparatus according to an eighth embodiment.

FIG. 18 is a diagram illustrating Example 3.

### DETAILED DESCRIPTION

An optical transmission system such as a WDM system transmits signal light by using a transmission system designed in advance. In some optical transmission systems, the signal light is transmitted by using a transmission system called “same wavelength single-core bidirectional transmission”. The same wavelength single-core bidirectional transmission is a transmission system to bi-directionally transmit the signal light having the same wavelength by a single-core optical fiber.

However, in the same wavelength single-core bidirectional transmission, the optical fiber is shared for both transmission and reception of the signal light. For this reason, return light caused by the transmission of the signal light may enter an optical transmission apparatus connected to the fiber end of the optical fiber. For example, when Fresnel reflection caused by the transmission of the signal light occurs in an optical connector for connecting the fiber end of the optical fiber and the optical transmission apparatus, light caused by Fresnel reflection may enter the optical transmission apparatus as the return light. In addition, when Rayleigh scattering caused by the transmission of the signal light occurs in the optical fiber, the light due to the Rayleigh scattering may enter the optical transmission apparatus as the return light.

When the optical transmission apparatus receives the signal light, if such return light enters the optical transmission apparatus, the return light is superimposed as noise on the signal light received by the optical transmission apparatus, and the signal quality of the signal light is degraded. In particular, if an amount of crosstalk defined by a relationship between the signal light received by the optical transmission apparatus and the return light is larger than a reference amount, an optical signal to noise ratio (OSNR) penalty may occur.

Accordingly, an object of one aspect of the present disclosure is to provide an optical transmission apparatus, an optical transmission system, and an optical transmission method that suppress an OSNR penalty due to the return light.

Hereinafter, an embodiment of the present disclosure will be described with reference to the drawings.

### First Embodiment

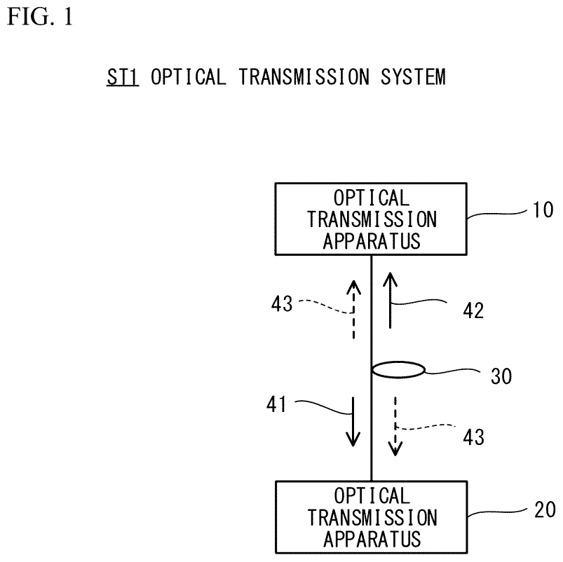

As illustrated in FIG. 1, an optical transmission system ST1 includes optical transmission apparatuses 10 and 20. The optical transmission apparatuses 10 and 20 are connected to each other through a single-core optical fiber 30. One of the fiber ends of the optical fiber 30 is connected to the optical transmission apparatus 10. The other end of the fiber ends of the optical fiber 30 is connected to the optical transmission apparatus 20. The signal light 41 is an example of first signal light, and the signal light 42 is an example of second signal light.

When a client signal is input to the optical transmission apparatus 10, the optical transmission apparatus 10 converts the client signal into signal light 41 and transmits the signal light 41 to the optical fiber 30. Thus, the signal light 41 propagates through the optical fiber 30. The optical transmission apparatus 20 receives the signal light 41 from the optical fiber 30. Upon receiving the signal light 41, the optical transmission apparatus 20 converts the signal light 41 into a client signal and outputs the client signal. The client signal is an electrical digital signal such as an Ethernet signal. The client signal may be a main signal or a control signal including only parameters for adjusting transmission characteristics or the like.

On the other hand, when the client signal is input to the optical transmission apparatus 20, the optical transmission apparatus 20 converts the client signal into signal light 42 and transmits the signal light 42 to the optical fiber 30. Thus, the signal light 42 propagates through the optical fiber 30 in the opposite direction to the signal light 41. The optical transmission apparatus 10 receives the signal light 42 from the optical fiber 30. Upon receiving the signal light 42, the optical transmission apparatus 10 converts the signal light 42 into a client signal and outputs the client signal. Although the wavelength of the signal light 42 is assumed to be the same as the wavelength of the signal light 41 in order to effectively use the signal band, the wavelength of the signal light 42 need not be the same as the wavelength of the signal light 41, as described later in detail.

Here, Rayleigh scattering may occur in the optical fiber 30 due to the transmission of the signal light 41. The Rayleigh scattering occurs regardless of whether the wavelengths of the signal light 41,42 are the same or different. When the Rayleigh scattering occurs, light (hereinafter referred to as Rayleigh scattering light) 43 due to the Rayleigh scattering enters the optical transmission apparatus 10 as return light. The Rayleigh scattering light 43 propagates through the optical fiber 30 in a direction (for example, an upward direction) opposite to a direction (for example, a downward direction) in which the signal light 41 propagates. When the Rayleigh scattering light 43 enters the optical transmission apparatus 10, the Rayleigh scattering light 43 is superimposed on the signal light 42, and the signal quality of the signal light 42 is degraded.

Although the Rayleigh scattering also occurs due to the transmission of the signal light 42, the Rayleigh scattering light due to the Rayleigh scattering is omitted in FIG. 1. The Rayleigh scattering light based on the transmission of the signal light 42 propagates through the optical fiber 30 in the direction (for example, the downward direction) opposite to the direction (for example, the upward direction) in which the signal light 42 propagates.

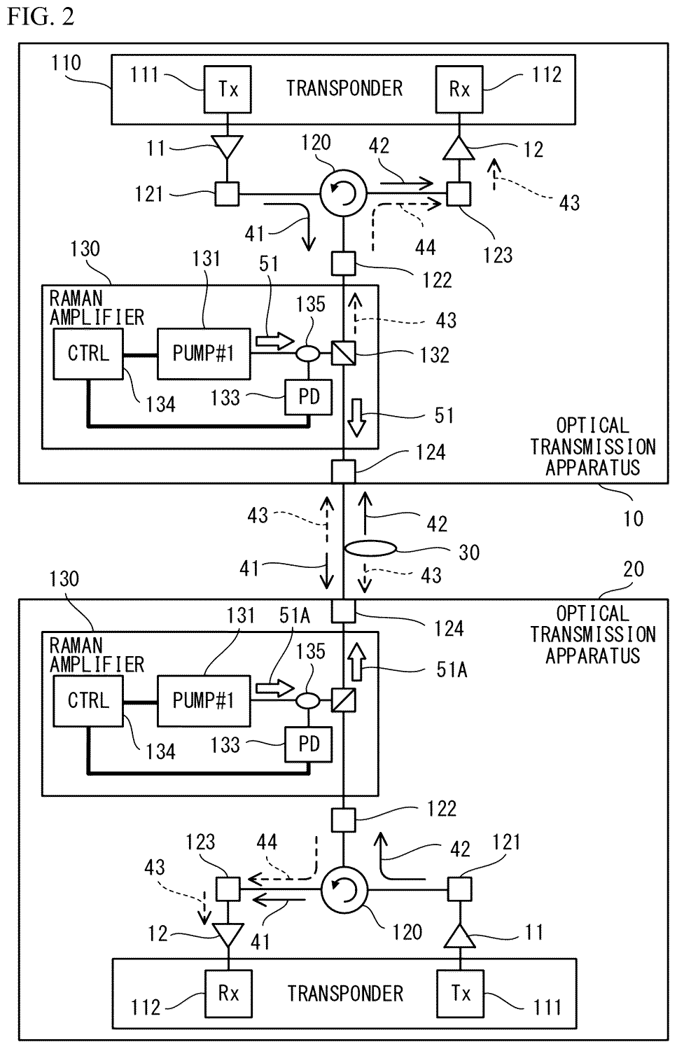

Next, the optical transmission apparatus 10 will be described in detail with reference to FIG. 2.

The optical transmission apparatus 10 includes a transponder 110, an optical circulator 120, and a Raman amplifier 130. The Raman amplifier 130 is an example of a light source. The transponder 110 includes an optical transmitter (denoted Tx in FIG. 2) 111 and an optical receiver (denoted Rx in FIG. 2) 112. The optical circulator 120 is connected to optical connectors 121, 122, and 123. The Raman amplifier 130 includes a primary pump light source (denoted by PUMP #1 in FIG. 2) 131, an optical filter 132, a PD (Photo Diode) 133, and a control unit (denoted by CTRL in FIG. 2) 134. The primary pump light source 131 is an example of a first light source.

An optical amplifier 11 is provided between the optical transmitter 111 and the optical connector 121. An optical amplifier 12 is provided between the optical receiver 112 and the optical connector 123. Each of the optical amplifiers 11 and 12 includes, for example, an erbium doped fiber amplifier (EDFA). Each of the optical amplifiers 11 and 12 may include a semiconductor optical amplifier (SOA) instead of the EDFA.

The optical transmitter 111 transmits the signal light 41 in the direction toward the optical transmission apparatus 20. The optical amplifier 11 amplifies the signal light 41. The optical circulator 120 allows the signal light 41 to be transmitted through in the direction of the optical connector 122. That is, the optical circulator 120 allows the signal light 41 traveling in the direction from the optical connector 121 to the optical connector 122 to be transmitted through. As a result, the optical circulator 120 guides the signal light 41 transmitted from the optical transmitter 111 to the optical fiber 30. On the other hand, the optical circulator 120 blocks the transmission of the signal light 41 in the direction of the optical connector 123. That is, the optical circulator 120 blocks the transmission of the signal light 41 traveling in the direction from the optical connector 121 to the optical connector 123. As a result, the signal light 41 can reach the optical connector 122, but cannot reach the optical connector 123.

The signal light 41 is amplified by the optical amplifier 11. Therefore, the optical power of the signal light 41 after transmitting through the optical circulator 120 is larger than the optical power of the signal light 41 before being amplified by the optical amplifier 11. The Fresnel reflection due to the transmission of the signal light 41 may occur in the optical connector 122 indirectly connected to the fiber end of the optical fiber 30. When the Fresnel reflection occurs, the light (hereinafter referred to as Fresnel reflected light) 44 due to the Fresnel reflection enters the optical circulator 120 as the return light.

The optical circulator 120 allows the signal light 42, the Rayleigh scattering light 43, and the Fresnel reflected light 44 from the optical transmission apparatus 20 opposing the optical transmission apparatus 10 to be transmitted through in the direction of the optical connector 123 through the optical fiber 30. That is, the optical circulator 120 allows the signal light 42 and the like traveling in the direction from the optical connector 122 to the optical connector 123 to be transmitted through. On the other hand, the optical circulator 120 blocks the transmission of the signal light 42, the Rayleigh scattering light 43, and the Fresnel reflected light 44 in the direction of the optical connector 121. That is, the optical circulator 120 blocks the transmission of the signal light 42 and the like traveling in the direction from the optical connector 122 to the optical connector 121. As a result, bidirectional transmission is performed on the optical connector 122, and unidirectional transmission is performed on the optical connectors 121 and 123.

The optical amplifier 12 amplifies the signal light 42, the Rayleigh scattering light 43, and the Fresnel reflected light 44. The optical receiver 112 receives the signal light 42, the Rayleigh scattering light 43, and the Fresnel reflected light 44 in the direction opposite to the direction of the signal light 41 toward the optical transmission apparatus 20. That is, the above-mentioned optical circulator 120 guides the signal light 42 from the optical fiber 30 to the optical receiver 112.

The primary pump light source 131 includes a laser light source and outputs incoherent pump light, for example, as primary pump light 51. The primary pump light 51 is guided in the same direction as the signal light 41 by the optical filter 132. As a result, the primary pump light 51 is guided to an optical connector 124 directly connected to the fiber end of the optical fiber 30, and propagates through the optical fiber 30. The primary pump light 51 amplifies the signal light 41 in the optical fiber 30 by a Raman amplification phenomenon. The Raman amplification phenomenon includes a distributed Raman system but does not include a concentrated Raman system.

Since the signal light 41 and the primary pump light 51 propagate in the same direction in the optical fiber 30, the forward-pumped Raman amplification is performed. Since the signal light 42 from the optical transmission apparatus 20 is transmitted in the direction opposite to the direction of the primary pump light 51, the backward-pumped Raman amplification is performed. Accordingly, the primary pump light 51 simultaneously performs the forward-pumped Raman amplification on the signal light 41 and the backward-pumped Raman amplification on the signal light 42.

The signal light 41 is subjected to the forward-pumped Raman amplification by the primary pump light 51, and then transmitted through the optical fiber 30, and is subjected to backward-pumped Raman amplification by the Raman amplifier 130 of the optical transmission apparatus 20. Similarly, the signal light 42 from the optical transmission apparatus 20 is subjected to the forward-pumped Raman amplification in the Raman amplifier 130 of the optical transmission apparatus 20, and then transmitted through the optical fiber 30, and is subjected to the backward-pumped Raman amplification by the primary pump light 51.

A branch coupler 135 is provided between the primary pump light source 131 and the optical filter 132. The branch coupler 135 guides a part of the primary pump light 51 to the PD 133. The PD 133 includes a monitor for measuring the optical power of the primary pump light 51, and electrically outputs the measurement result of the optical power to the control unit 134. The monitor includes, for example, an optical channel monitor (OCM). The control unit 134 includes a processor such as a field programmable gate array (FPGA) or a central processing unit (CPU), a driver circuit, and the like, and controls the operation of the primary pump light source 131 based on the measurement result.

The optical transmission apparatus 20 has basically the same configuration as that of the optical transmission apparatus 10, and therefore, a detailed description thereof will be omitted. For example, since the primary pump light 51 is emitted in the same direction as the signal light 41, the optical transmission apparatus 10 transmits the primary pump light 51 in the same direction as the signal light 41. For the same reason, the optical transmission apparatus 20 transmits primary pump light 51A output from the Raman amplifier 130 of the optical transmission apparatus 20 in the same direction as the signal light 42. The optical transmitter 111 provided in the optical transmission apparatus 20 is an example of an opposing transmitter. The optical receiver 112 provided in the optical transmission apparatus 20 is an example of an opposing receiver. The optical circulator 120 provided in the optical transmission apparatus 20 is an example of an opposing circulator. The Raman amplifier 130 included in the optical transmission apparatus 20 is an example of an opposing light source.

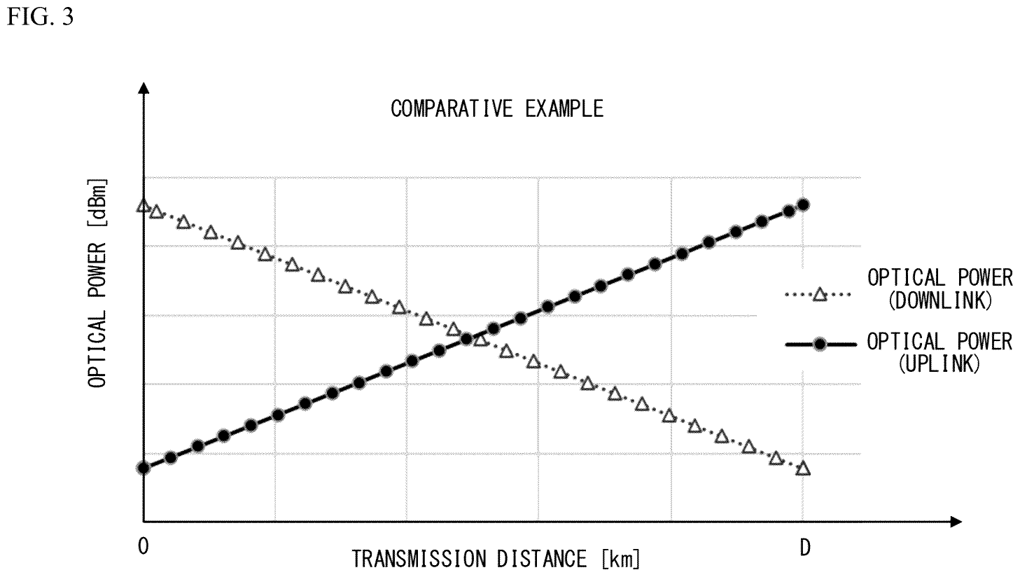

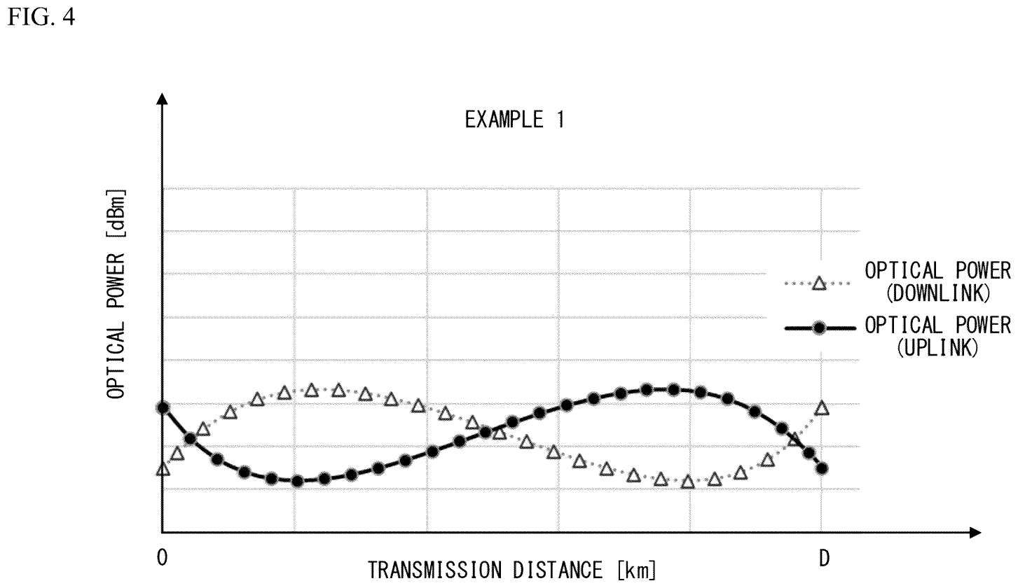

Next, the effect of the present disclosure will be described in comparison with the comparative example with reference to FIGS. 3 and 4. In FIGS. 3 and 4, the optical powers of the signal light 41 in the downlink direction and the signal light 42 in the uplink direction, which are opposed to each other in the bidirectional transmission, in the optical fiber 30 are plotted according to the distance from the optical transmission apparatus 10.

First, a comparative example in which the optical transmission apparatus 10 does not include the Raman amplifier 130 and the optical transmission apparatus 20 does not include the Raman amplifier (not illustrated) will be described with reference to FIG. 3. In the case of the comparative example, the optical power of the signal light 41 in the downlink direction decreases linearly as the transmission distance increases. That is, the optical power of the signal light 41 transmitted from the optical transmission apparatus 10 decreases as the signal light 41 propagates through the optical fiber 30. By the time the optical transmission apparatus 20, which is away from the optical transmission apparatus 10 by a transmission distance D such as several hundred km, receives the signal light 41, the optical power of the signal light 41 becomes minimum.

Similarly, the optical power of the signal light 42 in the uplink direction decreases linearly as the transmission distance increases. That is, the optical power of the signal light 42 transmitted from the optical transmission apparatus 20 decreases as the signal light 42 propagates through the optical fiber 30. By the time the optical transmission apparatus 10 receives the signal light 42, the optical power of the signal light 42 becomes minimum.

If the crosstalk amount defined by the relationship between the signal light 42 received by the optical transmission apparatus 10 and the return light is larger than a reference amount (e.g., −35 dB), the OSNR penalty may occur. When the error rate in the case where there is no crosstalk amount and the error rate in the case where there is a crosstalk amount are given, the OSNR penalty represents a difference between OSNRs corresponding to errors of both cases, based on a relationship between the OSNR and the error rate in the case where there is no crosstalk.

The crosstalk amount is defined by, for example, the following equation (1). The relationship between the crosstalk amount and the OSNR penalty can be found in the following document (1). In the present embodiment, the sign of the crosstalk amount defined in the document (1) is inverted.

$$Crosstalk amount = - 10 \times log ( optical power of return light / \\ reception power of signal light ) \qquad 〈 Equation ( 1 ) 〉$$

### <Document (1)>

“Penalties from In-Band Crosstalk for Advanced Optical Modulation Formats” P J Winzer, A H Gnauck, A Konczykowska, F Jorge, J Y Dupuy 2011 37th European Conference and Exhibition on Optical Communication, 2011

Thus, if the crosstalk amount is larger than the reference amount, the OSNR penalty may occur, and therefore it is desirable that the crosstalk amount is smaller than the reference amount. In the present embodiment, the crosstalk amount is defined by, for example, the optical power at the position of the optical connector 122 (see FIG. 2). Instead of the optical connector 122, the crosstalk amount may be defined by the optical connector 124.

In this case, the crosstalk amount is defined by the following equation (2). According to the equation (2), the crosstalk amount is reduced if the reception power is relatively increased as compared with the transmission power.

$$Crosstalk amount = - 10 \times log ( ( P\_Tx \times R ) / P\_Rx ) \qquad 〈 Equation ( 2 ) 〉$$

Wherein “P_Tx” represents a transmission power. “P_Rx” represents a reception power.
“R” represents a return loss in the optical connector.

In the first embodiment, the optical transmission apparatus 10 includes the Raman amplifier 130, and the optical transmission apparatus 20 includes the Raman amplifier 130. The signal light 41 propagates through the optical fiber 30 in the direction from the optical transmission apparatus 10 toward the optical transmission apparatus 20. The signal light 42 propagates through the optical fiber 30 in the direction from the optical transmission apparatus 20 toward the optical transmission apparatus 10. Due to such bidirectional transmission, for example, forward pumping based on the primary pump light 51 and backward pumping based on the primary pumping light transmitted from the optical transmission apparatus 20 are simultaneously performed on the signal light 41. That is, the signal light 41 is amplified by the Raman amplification phenomenon. When the incoherent pump light is employed as the primary pump light 51, even if it acts as forward pumping, deterioration in signal quality caused by RIN (Relative Intensity Noise) is suppressed.

On the other hand, the Raman amplification phenomenon occurs within the optical fiber 30 up to several tens of kilometers, but the increase in the power of the signal light is only about several dB, so that even if the signal light 41 is amplified by the Raman amplification phenomenon, the increase in the power of the signal light 41 is small. Therefore, it is assumed that the optical power of the Fresnel reflected light 44 caused by the transmission of the signal light 41 is maintained at the same level. When the optical amplifier 11 is set to reduce the output, the optical power of the signal light 41 decreases. This not only reduces the optical power of the Fresnel reflected light 44 but also reduces the optical power of the Rayleigh scattering light 43 caused by the transmission of the signal light 41. That is, the optical power of the return light is reduced.

Further, the optical power of the signal light 42 is amplified by the primary pump light 51 in the vicinity of the optical transmission apparatus 10 by the backward-pumped Raman amplification. That is, the optical power of the signal light 42 received by the optical transmission apparatus 10 increases. This reduces the ratio of the optical power of the return light to the reception power of the signal light 42 received by the optical transmission apparatus 10. As a result, the crosstalk amount is smaller than the reference amount, and the occurrence of the OSNR penalty is suppressed.

That is, as illustrated in FIG. 4, for example, in the vicinity of the optical transmission apparatus 10, unlike the case illustrated in FIG. 3, the optical power of the signal light 42 in the uplink direction and the optical power of the signal light 41 in the downlink direction are reversed, and the optical power of the signal light 42 in the uplink direction becomes relatively larger than the optical power of the signal light 41 in the downlink direction. This is because the optical power of the signal light 42 in the uplink direction is amplified by the backward-pumped Raman amplification by using the primary pump light 51 from the optical transmission apparatus 10 in the vicinity of the optical transmission apparatus 10. Also in the vicinity of the optical transmission apparatus 20, the optical power of the signal light 42 in the uplink direction transmitted by the optical transmission apparatus 20 and the optical power of the signal light 41 in the downlink direction received by the optical transmission apparatus 20 are reversed as in the case of the optical transmission apparatus 10. That is, even in the vicinity of the optical transmission apparatus 20, the optical power of the signal light 41 in the downlink direction becomes relatively larger than the optical power of the signal light 42 in the uplink direction. This is because the optical power of the signal light 41 in the downlink direction is amplified by the backward-pumped Raman amplification by using the primary pump light 51A from the optical transmission apparatus 20 in the vicinity of the optical transmission apparatus 20. As a result, the crosstalk amount becomes smaller than the reference amount, and the occurrence of the OSNR penalty is suppressed.

### Second Embodiment

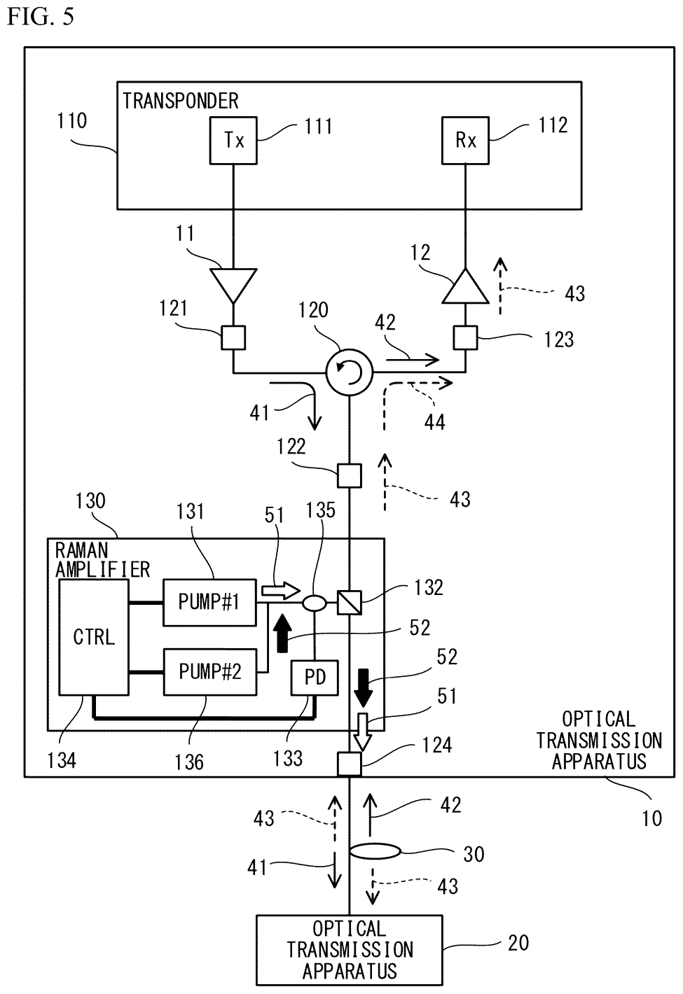

Next, a second embodiment of the present disclosure will be described with reference to FIG. 5. The same components as those of the optical transmission apparatus 10 according to the first embodiment are basically denoted by the same reference numerals, and detailed description thereof will be omitted. The same applies to the embodiments described later. The Raman amplifier 130 according to the second embodiment differs from the Raman amplifier 130 according to the first embodiment in that the Raman amplifier further includes a secondary pump light source (denoted as PUMP #2 in FIG. 2) 136. The secondary pump light source 136 is an example of a second light source.

The secondary pump light source 136 includes a laser light source and outputs the coherent pump light as secondary pump light 52. The secondary pump light 52 is used for Raman amplification of the primary pump light 51, and the wavelength band of the secondary pump light 52 is shorter than the wavelength band of the primary pump light 51. The secondary pump light 52 is guided by the optical filter 132 in the same direction as the signal light 41 and the primary pump light 51. As a result, the secondary pump light 52 is guided to the optical connector 124 connected to the fiber end of the optical fiber 30, and propagates through the optical fiber 30. The control unit 134 controls the operation of the secondary pump light source 136 based on the measurement result by the monitor included in the PD 133, as in the case of the primary pump light source 131.

The secondary pump light 52 amplifies the primary pump light 51 in the optical fiber 30 by the Raman amplification phenomenon. As a result, the optical power of the primary pump light 51 increases. Therefore, not only is the signal light 41 suppressed in signal quality deterioration caused by RIN, but also the optical power of the signal light 41 is greatly amplified by the increase in the optical power of the primary pump light 51 as compared with the case where the secondary pump light 52 is not present. Also in the second embodiment, the OSNR penalty due to the return light such as the Rayleigh scattering light 43 and the Fresnel reflected light 44 is suppressed.

### Third Embodiment

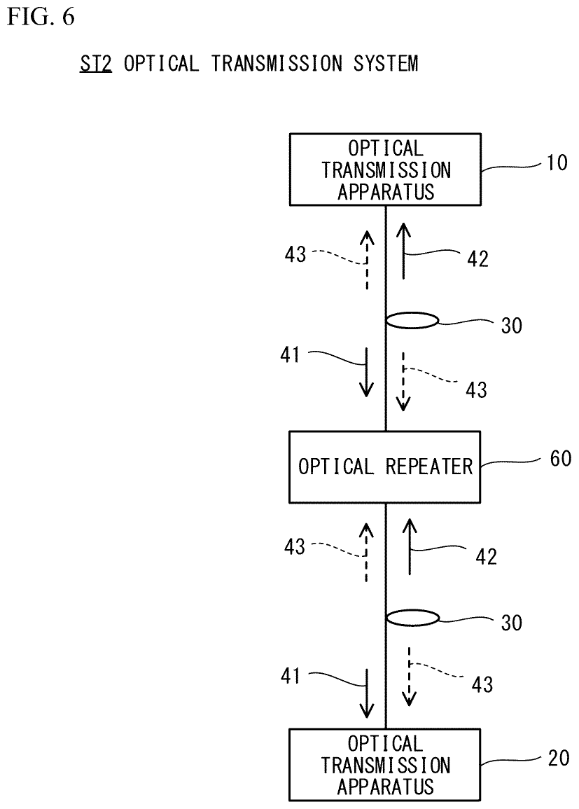

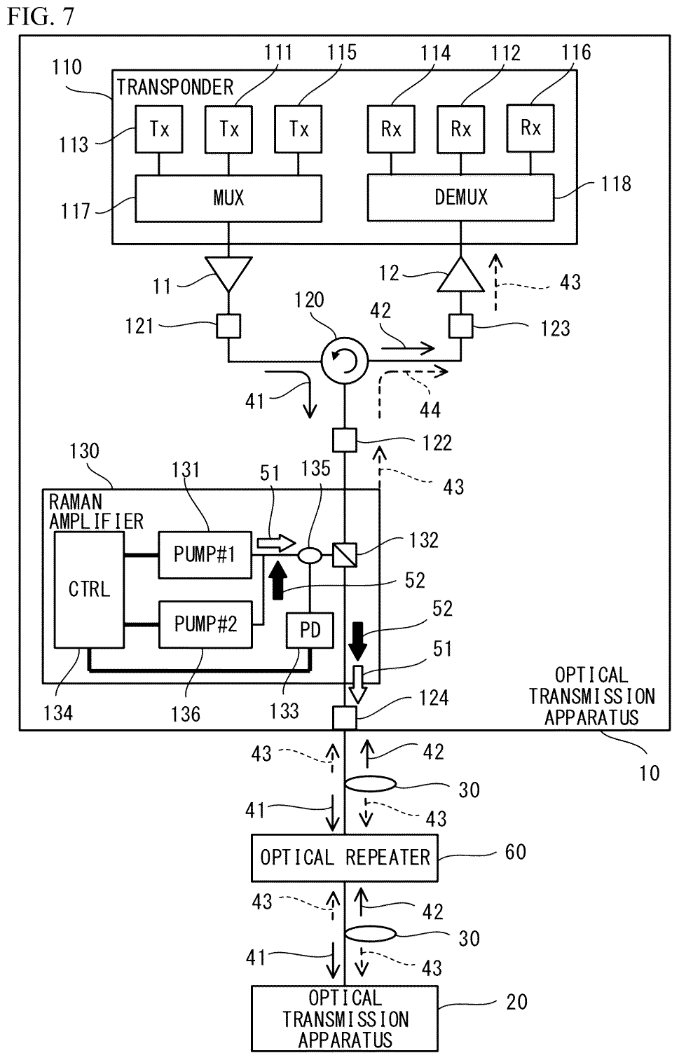

Next, a third embodiment of the present disclosure will be described with reference to FIGS. 6 to 8. The optical transmission system ST2 according to the third embodiment differs from the optical transmission system ST1 (see FIG. 1) according to the first embodiment in that the optical transmission system ST2 further includes an optical repeater 60 as illustrated in FIG. 6. As illustrated in FIG. 7, the transponder 110 according to the third embodiment differs from the transponder 110 (see FIG. 2) according to the first embodiment in that the transponder 110 further includes optical transmitters 113 and 115, optical receivers 114 and 116, an optical multiplexer (denoted by MUX in FIG. 7) 117, and an optical demultiplexer (denoted by DEMUX in FIG. 7) 118.

First, the transponder 110 will be described. The optical transmitters 111, 113 and 115 transmit signal lights having different center wavelengths. For example, the optical transmitter 111 transmits signal light with a center wavelength λ1. The optical transmitter 113 transmits signal light with a center wavelength λ2. The optical transmitter 115 transmits signal light with a center wavelength λ3. The optical multiplexer 117 multiplexes the signal lights transmitted from the optical transmitters 111, 113 and 115. When these signal lights are multiplexed, the optical multiplexer 117 outputs the multiplexed signal light as the signal light 41 in a wavelength band λx. The wavelength band λx includes the center wavelengths λ1, λ2, and λ3.

The optical demultiplexer 118 demultiplexes the signal light 42 in the wavelength band λx that is the same as the wavelength band λx of the signal light 41. For example, the optical demultiplexer 118 demultiplexes the signal light 42 in the wavelength band λx into the signal light with the center wavelength λ1, the signal light with the center wavelength λ2, and the signal light with the center wavelength λ3. The optical demultiplexer 118 outputs these three signal lights to the optical receiver 112, 114, and 116. The optical receiver 112 receives the signal light with the center wavelength λ1. The optical receiver 114 receives the signal light with the center wavelength λ2. The optical receiver 116 receives the signal light with the center wavelength λ3. As described above, in the third embodiment, the WDM technology is used in which a plurality of signal lights having different center wavelengths are multiplexed and transmitted.

The center wavelength may be a C-band or two bands of a C-band and an L-band, and may further include an S-band and an O-band. Furthermore, the primary pump light 51 and the secondary pump light 52 widen the gain wavelength characteristic in accordance with the WDM of the signal, and therefore, the primary pump light source 131 and the secondary pump light source 136 are made to have multiple wavelengths.

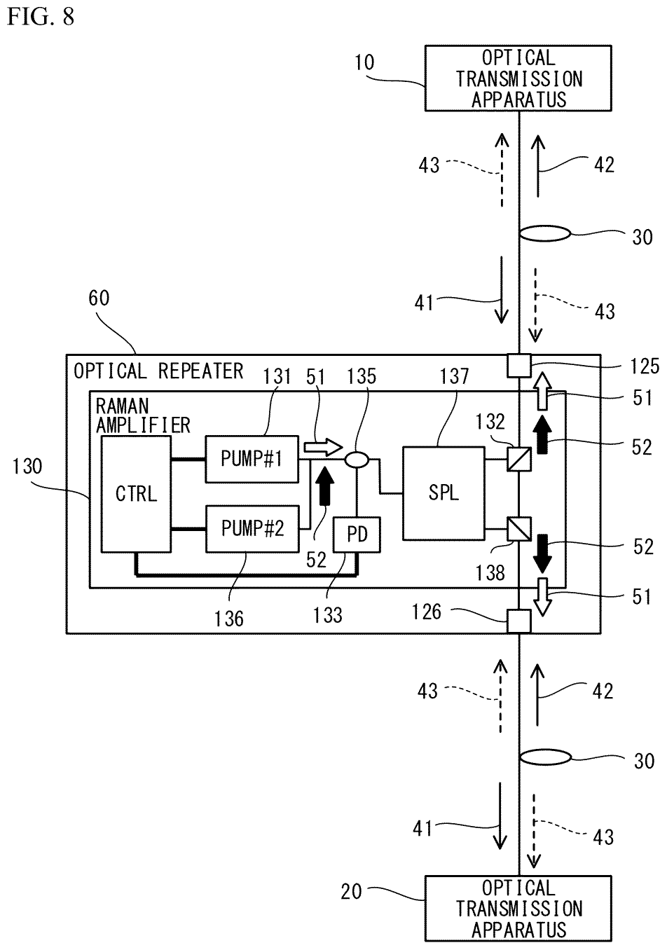

Next, the optical repeater 60 will be described. As illustrated in FIG. 8, the optical repeater 60 includes optical connectors 125 and 126 and the Raman amplifier 130. The Raman amplifier 130 included in the optical repeater 60 is an example of another light source. Also in the Raman amplifier 130 included in the optical repeater 60, the primary pump light source 131 and the secondary pump light source 136 are made to have multiple wavelengths in order to widen the gain wavelength characteristic in accordance with the WDM of the signal.

The optical connector 125 is connected to the fiber end of the optical fiber 30 connected to the optical transmission apparatus 10. The optical connector 126 is connected to the fiber end of the optical fiber 30 connected to the optical transmission apparatus 20. The optical fiber 30 connecting the optical transmission apparatus 10 and the optical repeater 60 is an example of a first optical fiber. The optical fiber 30 connecting the optical transmission apparatus 20 and the optical repeater 60 is an example of a second optical fiber.

The Raman amplifier 130 according to the third embodiment differs from the Raman amplifier 130 according to the second embodiment (see FIG. 5) in that the Raman amplifier 130 further includes an optical splitter (denoted as SPL in FIG. 8) 137 and an optical filter 138. The optical splitter 137 is provided between the optical filter 132 and the branch coupler 135. The optical filter 138 is provided between the optical filter 132 and the optical connector 126.

The optical splitter 137 divides the primary pump light 51, and guides one of the divided primary pump light 51 to the optical filter 132, and guides the other of the divided primary pump light 51 to the optical filter 138. The optical splitter 137 divides the secondary pump light 52, and guides one of the divided secondary pump light 52 to the optical filter 132, and guides the other of the divided secondary pump light 52 to the optical filter 138. Accordingly, one of the primary pump light 51 and one of the secondary pump light 52 are guided to the optical connector 125, and transmitted from the optical repeater 60 toward the optical transmission apparatus 10. On the other hand, the other of the primary pump light 51 and the other of the secondary pump light 52 are guided to the optical connector 126 and transmitted from the optical repeater 60 toward the optical transmission apparatus 20.

In the optical fiber 30 connected to the optical transmission apparatus 10, one of the secondary pump lights 52 amplifies one of the primary pump lights 51, and one of the amplified primary pump lights 51 amplifies the signal lights 41 and 42. In the optical fiber 30 connected to the optical transmission apparatus 20, the other of the secondary pump light 52 amplifies the other of the primary pump light 51, and the other of the amplified primary pump light 51 amplifies the signal lights 41 and 42. As described above, according to the third embodiment, the optical transmission system ST2 includes the optical repeater 60. Thus, the optical transmission system ST2 can extend the transmission distance longer than the optical transmission system ST1 while suppressing the OSNR penalty due to the return light. Although the case where one optical repeater 60 is included has been described, the same applies to the case where a plurality of optical repeaters 60 are included.

### Fourth Embodiment

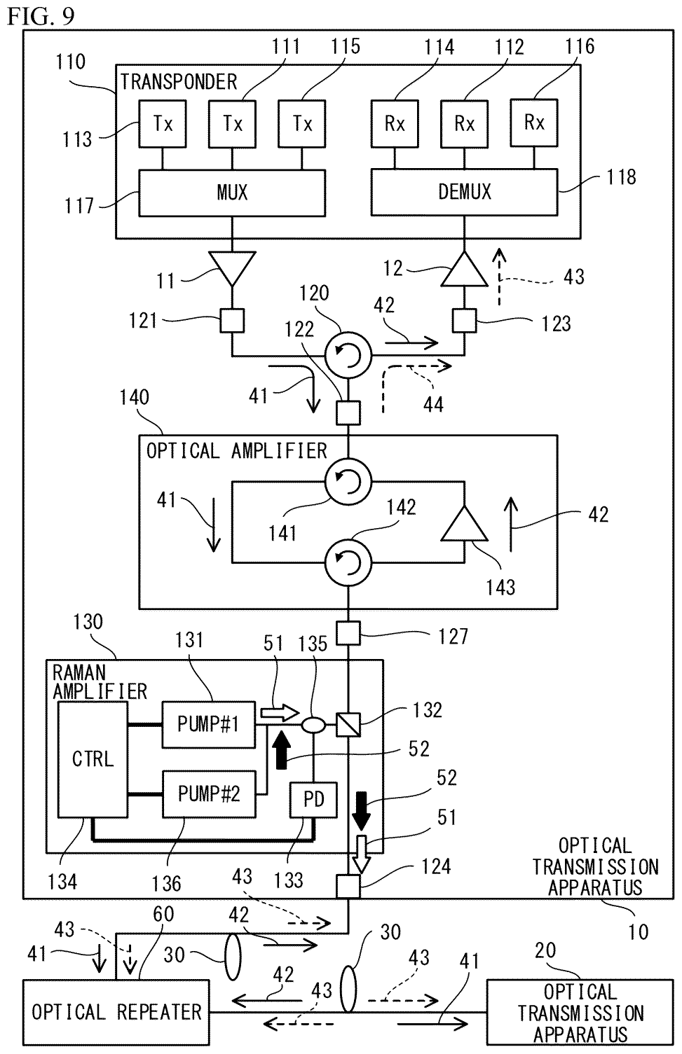

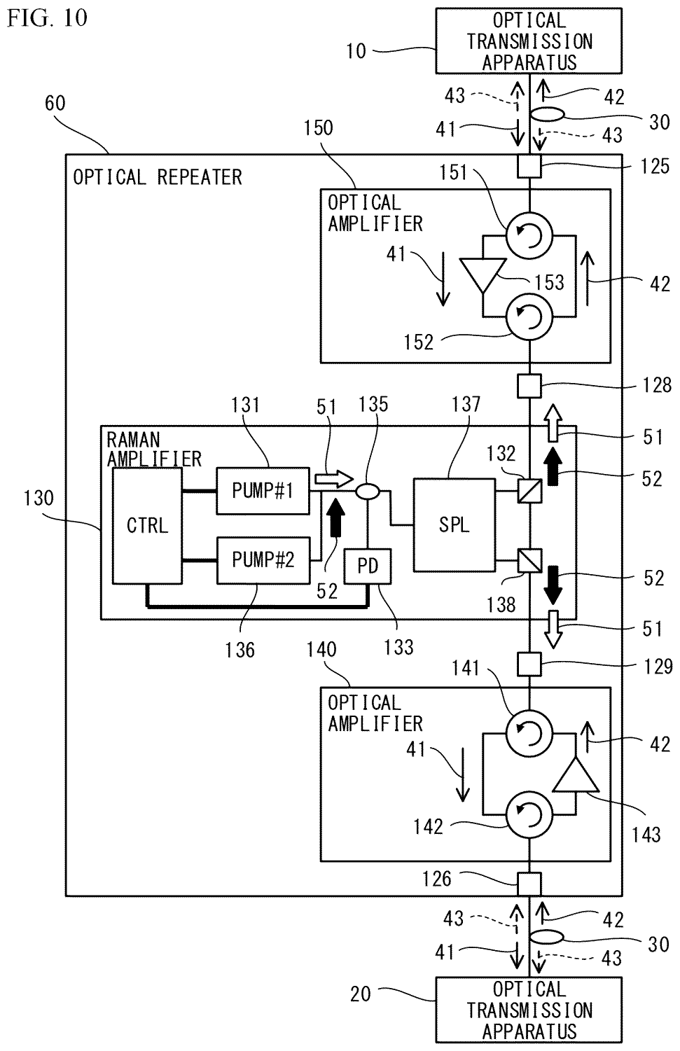

Next, a fourth embodiment of the present invention will be described with reference to FIGS. 9 to 11. As illustrated in FIG. 9, the optical transmission apparatus 10 according to the fourth embodiment differs from the optical transmission apparatus 10 (see FIG. 7) according to the third embodiment in that the optical transmission apparatus 10 further includes an optical amplifier 140. As illustrated in FIG. 10, the optical repeater 60 according to the fourth embodiment is different from the optical repeater 60 according to the third embodiment (see FIG. 8) in that the optical repeater 60 further includes optical amplifiers 140 and 150.

Since the optical transmission system according to the fourth embodiment has basically the same configuration as that of the optical transmission system ST2 according to the third embodiment, detailed description thereof will be omitted. The optical transmission apparatus 20 according to the fourth embodiment has basically the same configuration as the optical transmission apparatus 10 according to the fourth embodiment, and therefore, detailed description thereof will be omitted.

First, the optical amplifier 140 will be described with reference to FIG. 9. The optical amplifier 140 includes optical circulators 141 and 142, and an optical amplifier 143. The optical amplifier 143 includes, for example, an EDFA. The optical circulator 141 is connected to the optical connector 122, the optical circulator 142, and the optical amplifier 143. The optical circulator 142 is connected to an optical connector 127, the optical circulator 141, and the optical amplifier 143. The optical connector 127 is connected to the optical filter 132.

The optical circulator 141 allows the signal light 41 to be transmitted through in the direction of the optical circulator 142. That is, the optical circulator 141 allows the signal light 41 traveling in the direction from the optical connector 122 to the optical circulator 142 to be transmitted through. As a result, the optical circulator 141 guides the signal light 41 transmitted from each of the optical transmitters 111, 113, and 115 and multiplexed to the optical fiber 30. On the other hand, the optical circulator 141 blocks the transmission of the signal light 41 in the direction of the optical amplifier 143. That is, the optical circulator 141 blocks the transmission of the signal light 41 traveling in the direction from the optical connector 122 to the optical amplifier 143.

The optical circulator 141 allows the signal light 42 to be transmitted through in the direction of the optical connector 122. That is, the optical circulator 141 allows the signal light 42 traveling in the direction from the optical amplifier 143 to the optical connector 122 to be transmitted through. Thus, the optical circulator 141 guides the signal light 42 from the optical fiber 30 toward the optical receivers 112, 114, and 116. On the other hand, the optical circulator 141 blocks the transmission of the signal light 42 in the direction of the optical circulator 142. That is, the optical circulator 141 blocks the transmission of the signal light 42 traveling in the direction from the optical amplifier 143 to the optical circulator 142.

The optical circulator 142 allows the signal light 42 to be transmitted through in the direction of the optical amplifier 143. That is, the optical circulator 142 allows the signal light 42 traveling in the direction from the optical connector 127 to the optical amplifier 143 to be transmitted through. As a result, the optical circulator 142 guides the signal light 42 from the optical fiber 30 toward the optical receivers 112, 114, and 116. Thus, the signal light 42 enters the optical amplifier 143. The optical amplifier 143 amplifies the signal light 42 and guides the amplified signal light 42 to the optical circulator 141. On the other hand, the optical circulator 142 blocks the transmission of the signal light 42 in the direction of the optical circulator 141. That is, the optical circulator 142 blocks the transmission of the signal light 42 traveling in the direction from the optical connector 127 to the optical circulator 141.

The optical circulator 142 allows the signal light 41 to be transmitted through in the direction of the optical connector 127. That is, the optical circulator 142 allows the signal light 41 traveling in the direction from the optical circulator 141 to the optical connector 127 to be transmitted through. As a result, the optical circulator 142 guides the signal light 41 transmitted from each of the optical transmitters 111, 113, and 115 and multiplexed to the optical fiber 30. On the other hand, the optical circulator 142 blocks the transmission of the signal light 41 in the direction of the optical amplifier 143. That is, the optical circulator 142 blocks the transmission of the signal light 41 traveling in the direction from the optical circulator 141 to the optical amplifier 143.

Next, the optical amplifier 150 will be described with reference to FIG. 10. As described above, the optical repeater 60 includes the optical amplifier 140, but the optical amplifier 140 included in the optical repeater 60 basically has the same configuration as the optical amplifier 140 included in the optical transmission apparatus 10, and therefore, detailed description thereof will be omitted. For example, the optical circulator 141 of the optical amplifier 140 is connected to an optical connector 129, and the optical circulator 142 is connected to the optical connector 126.

The optical amplifier 150 includes optical circulators 151 and 152, and an optical amplifier 153. The optical amplifier 153 includes, for example, an EDFA. The optical circulator 151 is connected to the optical connector 125, the optical circulator 152, and the optical amplifier 153. The optical circulator 152 is connected to an optical connector 128, the optical circulator 151, and the optical amplifier 153. The optical connector 128 is connected to the optical filter 132.

The optical circulator 151 allows the signal light 41 to be transmitted through in the direction of the optical amplifier 153. That is, the optical circulator 151 allows the signal light 41 traveling in the direction from the optical connector 125 to the optical amplifier 153 to be transmitted through. Thus, the signal light 41 enters the optical amplifier 153. The optical amplifier 153 amplifies the signal light 41 and guides the amplified signal light 41 to the optical circulator 152. On the other hand, the optical circulator 151 blocks the transmission of the signal light 41 in the direction of the optical circulator 152. That is, the optical circulator 151 blocks the transmission of the signal light 41 traveling in the direction from the optical connector 125 to the optical circulator 152.

The optical circulator 151 allows the signal light 42 to be transmitted through in the direction of the optical connector 125. That is, the optical circulator 151 allows the signal light 42 traveling in the direction from the optical circulator 152 to the optical connector 125 to be transmitted through. On the other hand, the optical circulator 151 blocks the transmission of the signal light 42 in the direction of the optical amplifier 153. That is, the optical circulator 151 blocks the transmission of the signal light 42 traveling in the direction from the optical circulator 152 to the optical amplifier 153.

The optical circulator 152 allows the signal light 41 to be transmitted through in the direction of the optical connector 128. That is, the optical circulator 152 allows the signal light 41 traveling in the direction from the optical amplifier 153 to the optical connector 128 to be transmitted through. On the other hand, the optical circulator 152 blocks the transmission of the signal light 41 in the direction of the optical circulator 151. That is, the optical circulator 152 blocks the transmission of the signal light 41 traveling in the direction from the optical amplifier 153 to the optical circulator 151.

The optical circulator 152 allows the signal light 42 to be transmitted through in the direction of the optical circulator 151. That is, the optical circulator 152 allows the signal light 42 traveling in the direction from the optical connector 128 to the optical circulator 151 to be transmitted through. On the other hand, the optical circulator 152 blocks the transmission of the signal light 42 in the direction of the optical amplifier 153. That is, the optical circulator 152 blocks transmission of the signal light 42 traveling in the direction from the optical connector 128 to the optical amplifier 153.

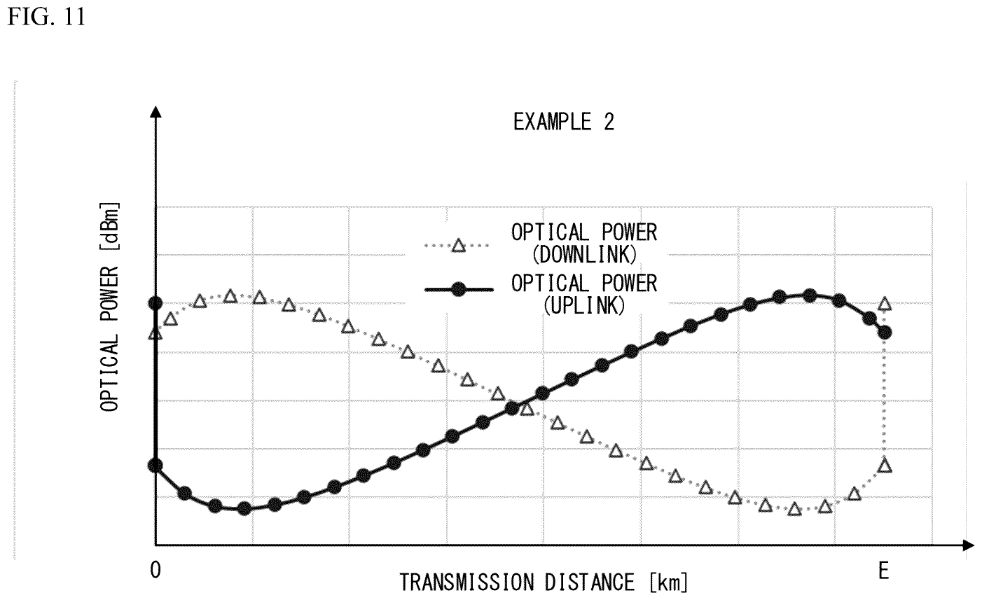

The variation in the optical power of each of the signal lights 41 and 42 according to the fourth embodiment will be described with reference to FIG. 11. FIG. 11 illustrates variations in optical power from the optical connector 129 of the optical repeater 60 (see FIG. 10) to an optical connector (not illustrated) of the optical transmission apparatus 20 to which the fiber end of the optical fiber 30 is connected. In FIG. 11, the position of the optical connector of the optical transmission apparatus 20 is indicated by “E” km with reference to the position of the optical connector 128.

The signal light 41 in the downlink direction transmitted from the optical repeater 60 is amplified in the optical fiber 30 based on the primary pump light 51 and the secondary pump light 52 transmitted as the forward pump light from the optical repeater 60. As a result, the optical power of the signal light 41 in the downlink direction from a reference (i.e., 0 km) gradually increases. Thereafter, since there is no opportunity for amplification of the signal light 41 in the downlink direction, the optical power of the signal light 41 in the downlink direction gradually decreases as the signal light 41 propagates through the optical fiber 30.

In the vicinity where the optical transmission apparatus 20 receives the signal light 41 in the downlink direction, the signal light 41 is amplified in the optical fiber 30 based on the primary pump light and the secondary pump light transmitted as the backward pump light from the optical transmission apparatus 20. As a result, the optical power of the signal light 41 in the downlink direction gradually increases. When the optical transmission apparatus 20 receives the signal light 41, the optical power of the signal light 41 is rapidly increased by the optical amplifier that the optical transmission apparatus 20 has, as in the case of the optical transmission apparatus 10.

The same is basically true for the signal light 42 in the uplink direction transmitted from the optical transmission apparatus 20 as for the signal light 41. That is, the signal light 42 in the uplink direction is amplified in the optical fiber 30 based on the primary pump light and the secondary pump light transmitted as the forward pump light from the optical transmission apparatus 20. The signal light 42 in the uplink direction is amplified in the optical fiber 30 based on the primary pump light 51 and the secondary pump light 52 transmitted as the backward pump light from the optical repeater 60. When the optical repeater 60 receives the signal light 42 in the uplink direction, the optical power of the signal light 42 in the uplink direction is rapidly increased by the optical amplifier 143 of the optical amplifier 140 included in the optical repeater 60.

As described above, in the fourth embodiment, the optical transmission apparatus 10 has the optical amplifier 140, and the optical repeater 60 has the optical amplifiers 140 and 150. Thus, even when the optical fiber 30 has a long fiber length and the optical power at the time of reception is smaller than the optical power at the time of transmission only by Raman amplification, the signal light 41 is amplified by the optical amplifier 150, and the signal light 42 is amplified by the optical amplifier 140. That is, even when the optical fiber 30 has the long fiber length, the signal lights 41 and 42 are amplified by the Raman amplifier 130 and the optical amplifiers 140 and 150, and thus the OSNR penalty due to the return light is suppressed.

### Fifth Embodiment

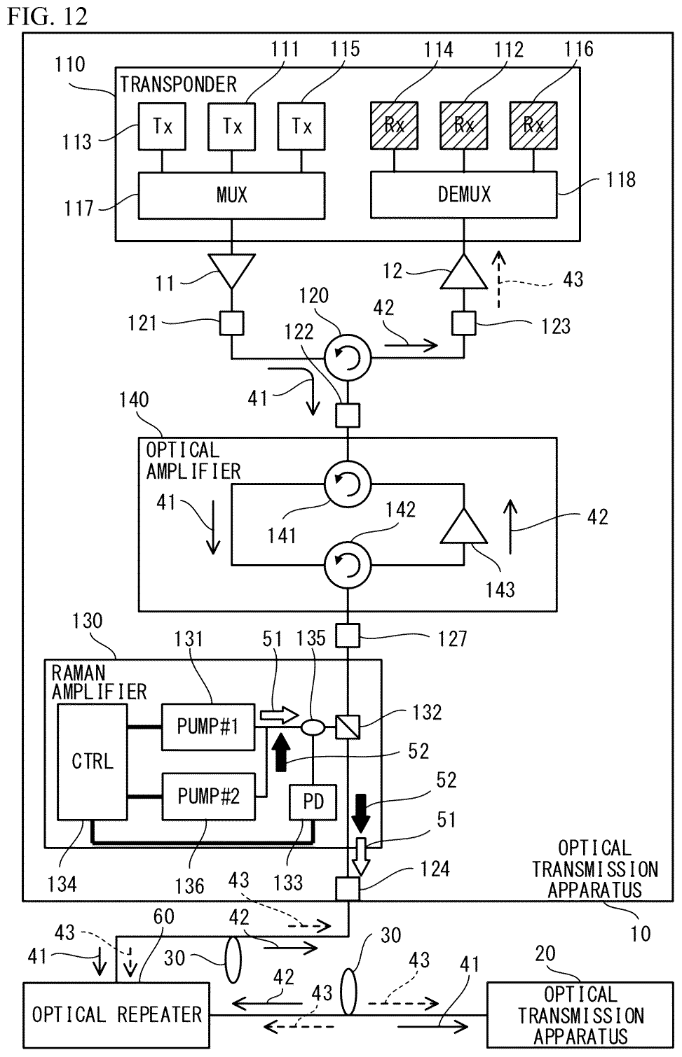

Next, a fifth embodiment of the present disclosure will be described with reference to FIG. 12. In the fifth embodiment, the signal light 41 in the wavelength band λx and the signal light 42 in a wavelength band Ay will be described as an example. That is, the fifth embodiment is different from the third embodiment described by taking the signal lights 41 and 42 in the wavelength band λx as an example.

First, as in the third embodiment, the optical transmitter 111 transmits the signal light with the center wavelength λ1. The optical transmitter 113 transmits the signal light with the center wavelength λ2. The optical transmitter 115 transmits the signal light with the center wavelength λ3. The optical multiplexer 117 multiplexes the signal lights transmitted from the optical transmitters 111, 113, and 115. When these signal lights are multiplexed, the optical multiplexer 117 outputs the multiplexed signal light as the signal light 41 in the wavelength band λx. The wavelength band λx includes the center wavelengths λ1, λ2, and λ3.

On the other hand, the optical demultiplexer 118 demultiplexes the signal light 42 in the wavelength band λy different from the wavelength band λx of the signal light 41. For example, the optical demultiplexer 118 demultiplexes the signal light 42 in the wavelength band λy into signal light with a center wavelength λ4, signal light with a center wavelength λ5, and signal light with s center wavelength λ6. The optical demultiplexer 118 outputs these three signal lights to the optical receiver 112, 114, and 116. The optical receiver 112 receives the signal light with the center wavelength λ4. The optical receiver 114 receives the signal light with the center wavelength λ5. The optical receiver 116 receives the signal light with the center wavelength λ6.

In this way, when the wavelength bands of the signal light 41 and the signal light 42 are different from each other, the OSNR penalty due to the Fresnel reflected light 44 is avoided. Therefore, when the wavelength bands of the signal light 41 and the signal light 42 are different from each other, the OSNR penalty due to the Rayleigh scattering light 43 is suppressed independently.

### Sixth Embodiment

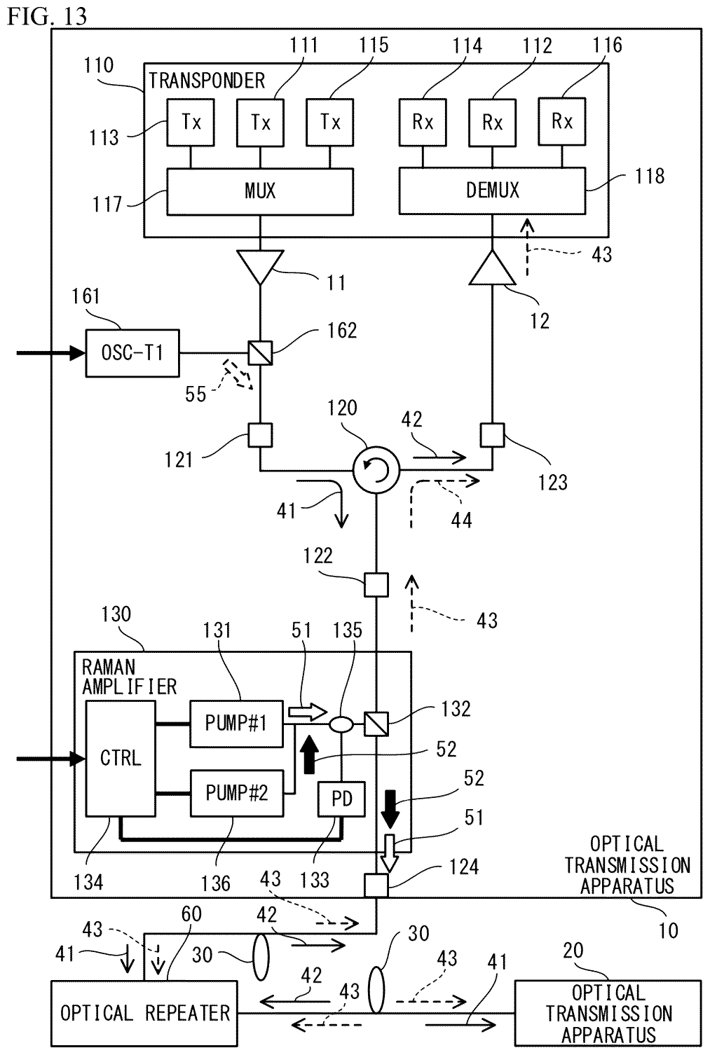

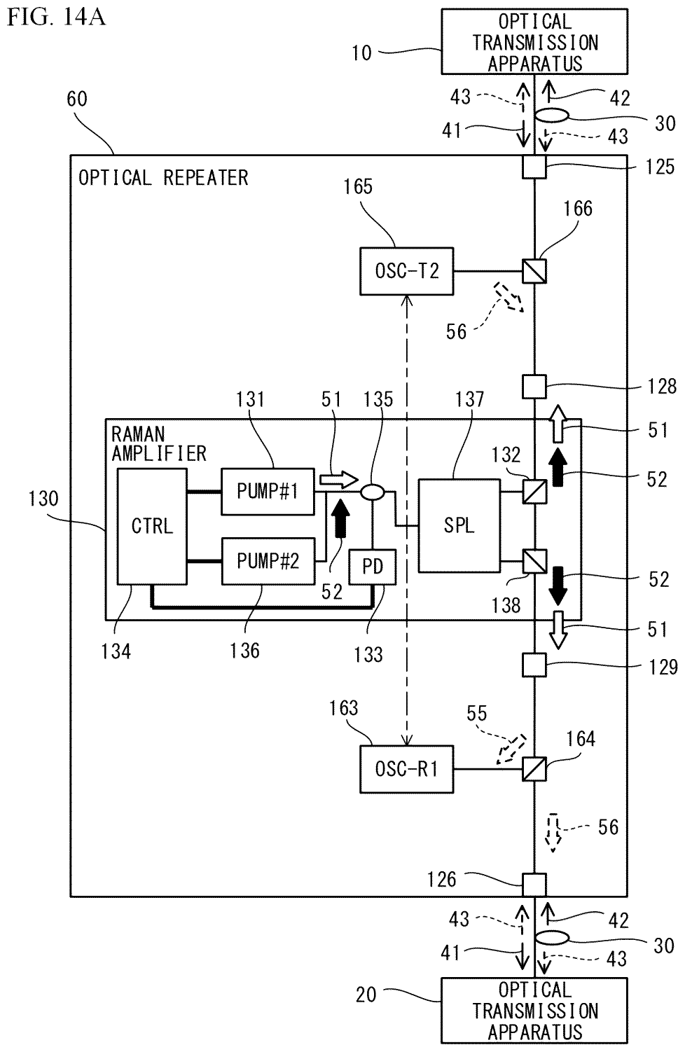

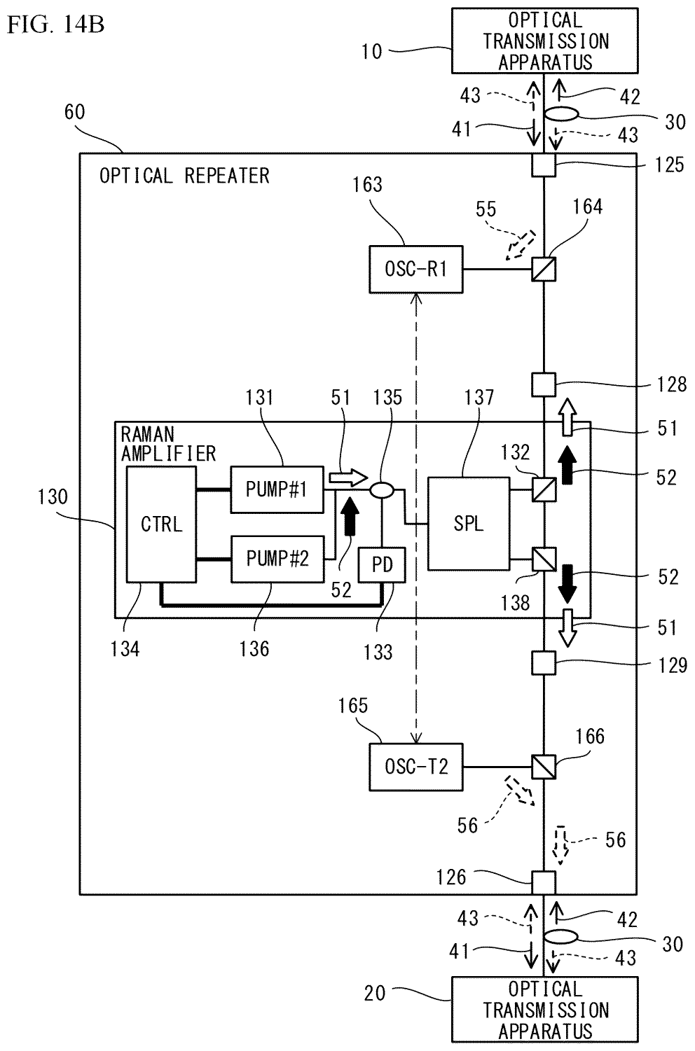

Next, a sixth embodiment of the present disclosure will be described with reference to FIGS. 13 to 15. As illustrated in FIG. 13, the optical transmission apparatus 10 according to the sixth embodiment differs from the optical transmission apparatus 10 according to the third embodiment (see FIG. 7) in that the optical transmission apparatus 10 according to the sixth embodiment further includes an optical supervisory channel (OSC) light first transmission unit (represented as OSC-T1 in FIG. 13) 161. As illustrated in FIG. 14A, the optical repeater 60 according to the sixth embodiment is different from the optical repeater 60 according to the third embodiment (see FIG. 8) in that the optical repeater 60 according to the sixth embodiment further includes an OSC light first reception unit (denoted as OSC-R1 in FIG. 14A) 163 and an OSC light second transmission unit 165. Although not illustrated, the optical transmission apparatus 20 according to the sixth embodiment is provided with the OSC light second reception unit so as to correspond to the optical transmission apparatus 10.

As illustrated in FIG. 13, the OSC light first transmission unit 161 is connected to an optical filter 162. The optical filter 162 is provided between the optical amplifier 11 and the optical connector 121. The OSC light first transmitter 161 transmits the OSC light 55, for example, based on the control of the network controller that manages the optical transmission system ST2. The optical filter 162 guides the OSC light 55 to the optical connector 121. Therefore, the OSC light 55 is transmitted from the optical transmission apparatus 10 to the optical repeater 60 in the same manner as the signal light 41.

As illustrated in FIG. 14A, the OSC light first reception unit 163 is connected to an optical filter 164. The optical filter 164 is provided between the optical connector 126 and the optical connector 129. The optical filter 164 guides the OSC light 55 to the OSC light first reception unit 163. As a result, the OSC light first reception unit 163 receives the OSC light 55 transmitted from the optical transmission apparatus 10.

The OSC light first reception unit 163 and the OSC light second transmission unit 165 communicate with each other. When the reception of the OSC light 55 is notified from the OSC light first reception unit 163, the OSC light second transmission unit 165 transmits the OSC light 56 having a wavelength different from that of the OSC light 55. The OSC light second transmission unit 165 may transmit the OSC light 56 based on the control of the network controller. The OSC light second transmission unit 165 is connected to an optical filter 166. The optical filter 166 is provided between the optical connector 125 and the optical connector 128. The optical filter 166 guides the OSC light 56 to the optical connector 128.

Therefore, the OSC light 56 is transmitted from the optical repeater 60 to the optical transmission apparatus 20 in the same manner as the signal light 41. Since the OSC light 56 and the OSC light 55 have different wavelengths from each other, the OSC light 56 is not guided to the OSC light first reception unit 163 but is guided to the optical connector 126. As a result, the OSC light 56 is transmitted from the optical repeater 60 to the optical transmission apparatus 20.

The OSC light second reception unit of the optical transmission apparatus 20 receives the OSC light 56 transmitted from the optical repeater 60 through the optical filter. When receiving the OSC light 56, the OSC light second reception unit notifies the network controller of the communication of the OSC light 56. The network controller instructs the optical transmission apparatuses 10 and 20 and the control unit 134 of the optical repeater 60 to drive the primary pump light source 131 and the secondary pump light source 136.

As a result, each control unit 134 drives the primary pump light source 131 and the secondary pump light source 136. Each control unit 134 drives the primary pump light source 131, so that the primary pump light source 131 outputs the primary pump light 51. Further, each control unit 134 drives the secondary pump light source 136, so that the secondary pump light source 136 outputs the secondary pump light 52.

On the other hand, when the OSC light first reception unit 163 does not receive the OSC light 55, it is assumed that a fiber breakage has occurred in the optical fiber 30 connecting the optical transmission apparatus 10 and the optical repeater 60. Accordingly, when the communication of the OSC light 55 is not notified to the network controller, the network controller instructs the control unit 134 to decrease the output of the primary pump light source 131 and the secondary pump light source 136 or to stop driving the primary pump light source 131 and the secondary pump light source 136. As a result, the optical power of the primary pump light 51 and the secondary pump light 52 is weakened, or the output of the primary pump light 51 and the secondary pump light 52 is stopped.

As a result, the safety of the operator who restores the optical fiber 30 is secured. When the OSC light 56 is not received by the OSC light second reception unit, it is assumed that the fiber breakage has occurred in the optical fiber 30 connecting the optical repeater 60 and the optical transmission apparatus 20. In this case, as in the case of the OSC light 55, the network controller instructs the control unit 134 to decrease the output of the primary pump light source 131 and the secondary pump light source 136 or to stop driving the primary pump light source 131 and the secondary pump light source 136.

When the optical transmission apparatus 10 includes the optical amplifier 140 and the network controller is not notified of the communication of the OSC light 55, the network controller may instruct the control unit 134 to stop driving the optical amplifier 140. Specifically, the network controller may instruct the control unit 134 to stop driving the optical amplifier 143. In this case, the safety of the worker is secured as well. The same applies to the case where the optical repeater 60 includes the optical amplifiers 140 and 150.

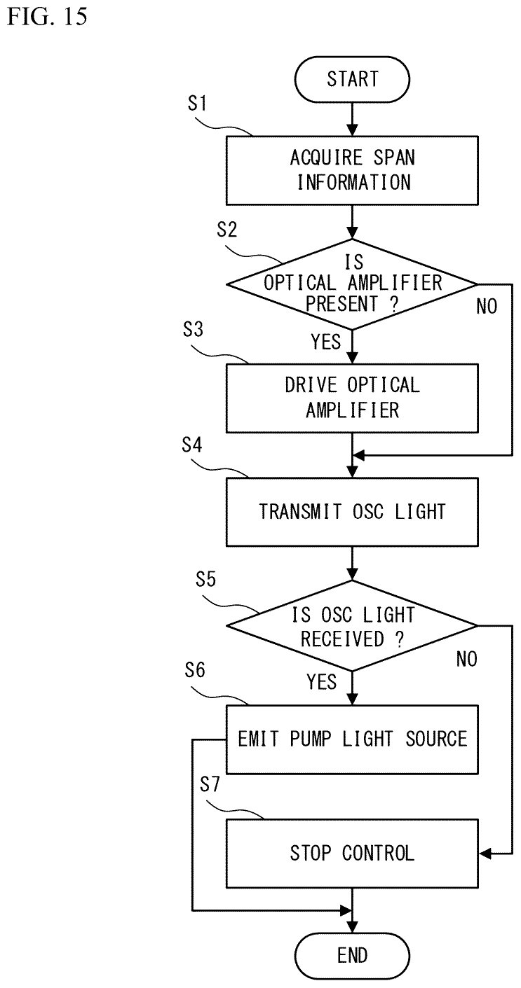

An example of the operation of the control unit 134 will be described with reference to FIG. 15.

When the optical transmission apparatuses 10 and 20 and the optical repeater 60 are activated, the respective control units 134 of the optical transmission apparatuses 10 and 20 and the optical repeater 60 acquire span information (step S1). For example, each control unit 134 acquires the span information from the network controller. The span information includes the fiber type of the optical fiber 30, the span length of the span, the span loss, and the like. The fiber type includes, for example, SMF (Single Mode Fiber). The span represents, for example, a transmission section between the optical transmission apparatus 10 and the optical repeater 60, a transmission section between the optical repeater 60 and the optical transmission apparatus 20, a transmission section between the optical repeaters 60, and the like.

When the span information is acquired, each control unit 134 determines whether the optical amplifier 140 and/or the optical amplifier 150 is present (step S2). For example, the control unit 134 of the optical transmission apparatus 10 determines whether the optical transmission apparatus 10 includes the optical amplifier 140. The control unit 134 of the optical repeater 60 determines whether the optical repeater 60 includes the optical amplifiers 140 and 150. When the optical amplifier 140 and/or the optical amplifier 150 is present (step S2: YES), each control unit 134 drives the optical amplifier 140 and/or the optical amplifier 150 (step S3). On the other hand, when the optical amplifier 140 and/or the optical amplifier 150 is not present (step S2: NO), each control unit 134 skips the process of step S3.

Next, each control unit 134 transmits the OSC light (step S4). For example, the control unit 134 of the optical transmission apparatus 10 drives the OSC light first transmission unit 161, so that the OSC light first transmission unit 161 transmits the OSC light 55. The control unit 134 of the optical repeater 60 drives the OSC light second transmission unit 165, so that the OSC light second transmission unit 165 transmits the OSC light 56.

When the OSC light is transmitted, each control unit 134 determines whether the OSC light is received (step S5). For example, the control unit 134 of the optical repeater 60 determines whether the OSC light first reception unit 163 receives the OSC light 55. Moreover, the control unit of the optical transmission apparatus 20 determines whether the OSC light second reception unit receives the OSC light 56. When the OSC light is received (step S5: YES), each control unit 134 emits the pump light source (step S6).

For example, the control unit 134 of the optical transmission apparatus 10 emits light from the primary pump light source 131 and the secondary pump light source 136. Accordingly, the primary pump light source 131 transmits the primary pump light 51, and the secondary pump light source 136 transmits the secondary pump light 52. The control unit 134 of the optical repeater 60 emits light from the primary pump light source 131 and the secondary pump light source 136. Accordingly, the primary pump light source 131 transmits the primary pump light 51, and the secondary pump light source 136 transmits the secondary pump light 52. Each control unit 134 accesses a table in which the span information is associated with the set temperature and set current of the primary pump light source 131 and the secondary pump light source 136, specifies the set temperature and the set current according to the span information, and emits light from the primary pump light source 131 and the secondary pump light source 136. When the pump light source emits light, each control unit 134 ends the process.

On the other hand, when the OSC light is not received (step S5: NO), each control unit 134 stops the control (step S7), and ends the process. For example, when the OSC light is not received, the fiber breakage of the optical fiber 30 is assumed, and thus each control unit 134 stops the transmission of the OSC light 55, 56. As described above, according to the sixth embodiment, when the communication of the OSC light 55, 56 is confirmed, the primary pump light 51 and the secondary pump light 52 are transmitted, and the OSNR penalty due to the return light is suppressed.

Here, an example of assigning different wavelengths to the OSC lights 55 and 56 and monitoring for fiber breakage or connector disconnection between the optical fiber 30 and the Raman amplifier 130 is illustrated. As a simpler configuration, the monitoring of the fiber breakage or the connector disconnection between the optical fiber 30 and the optical transmission apparatus 10, between the optical fiber 30 and the optical transmission apparatus 20, or between the optical fiber 30 and the optical repeater 60 can be performed in the same manner. Specifically, as illustrated in FIG. 14B, the positions of the OSC light second transmission unit 165 and the optical filter 166 are exchanged with those of the OSC light first reception unit 163 and the optical filter 164.

### Seventh Embodiment

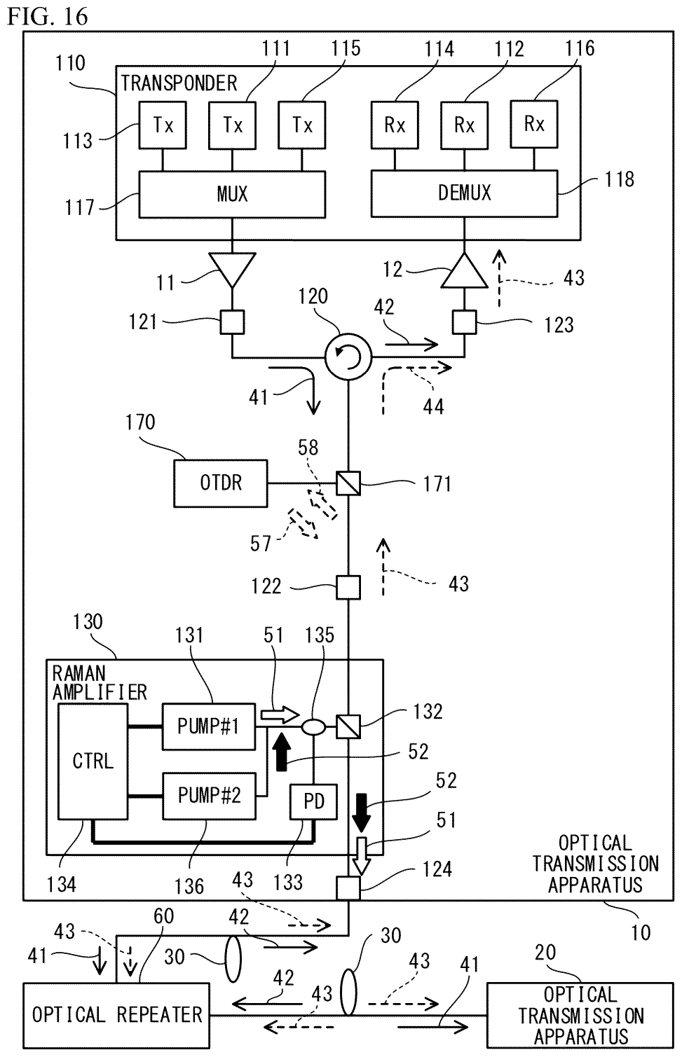

Next, a seventh embodiment of the present disclosure will be described with reference to FIG. 16. The optical transmission apparatus 10 according to the seventh embodiment is different from the optical transmission apparatus 10 (see FIG. 7) according to the third embodiment in that the optical transmission apparatus 10 according to the seventh embodiment further includes an optical time domain reflectometer (OTDR) 170. The OTDR 170 makes the optical pulse 57 incident on the optical fiber 30, detects reflected light 58 from the optical fiber 30, and confirms the communication of the optical pulse 57 based on the reception timing of the reflected light 58.

The OTDR 170 is connected to an optical filter 171. The optical filter 171 is provided between the optical circulator 120 and the optical connector 122. The optical filter 171 guides the optical pulses 57 to the optical connector 122. Thus, the optical transmission apparatus 10 can transmit the optical pulse 57 to the optical fiber 30. On the other hand, the optical filter 171 guides the reflected light 58 to the OTDR 170. This allows the OTDR 170 to receive the reflected light 58. In this way, the communication of the optical pulse 57 may be confirmed by using the optical pulse 57 or the reflected light 58 instead of the OSC light 55 and 56.

### Eighth Embodiment

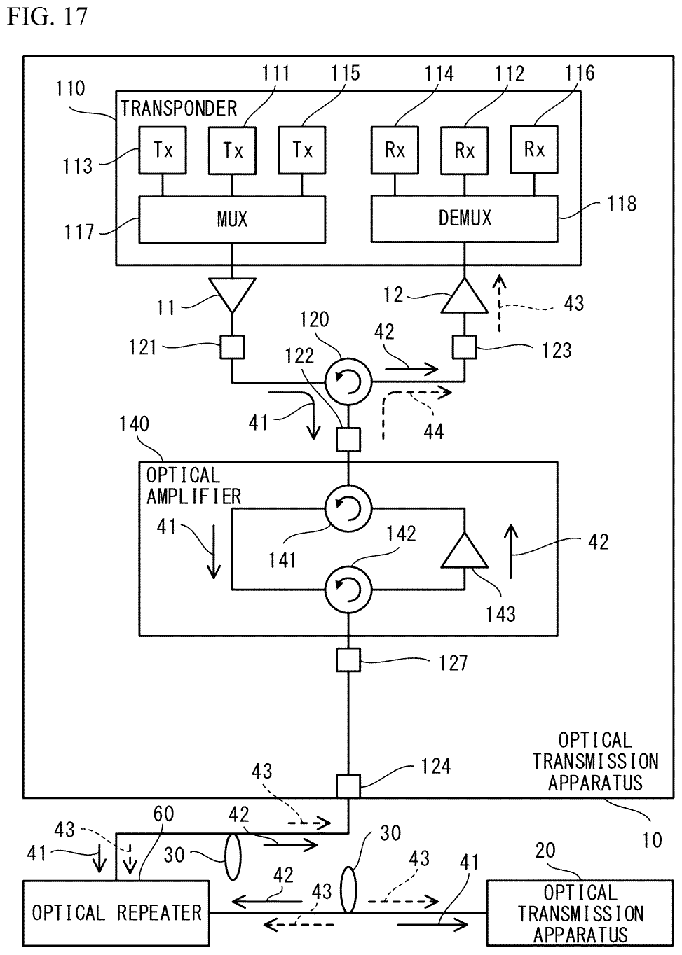

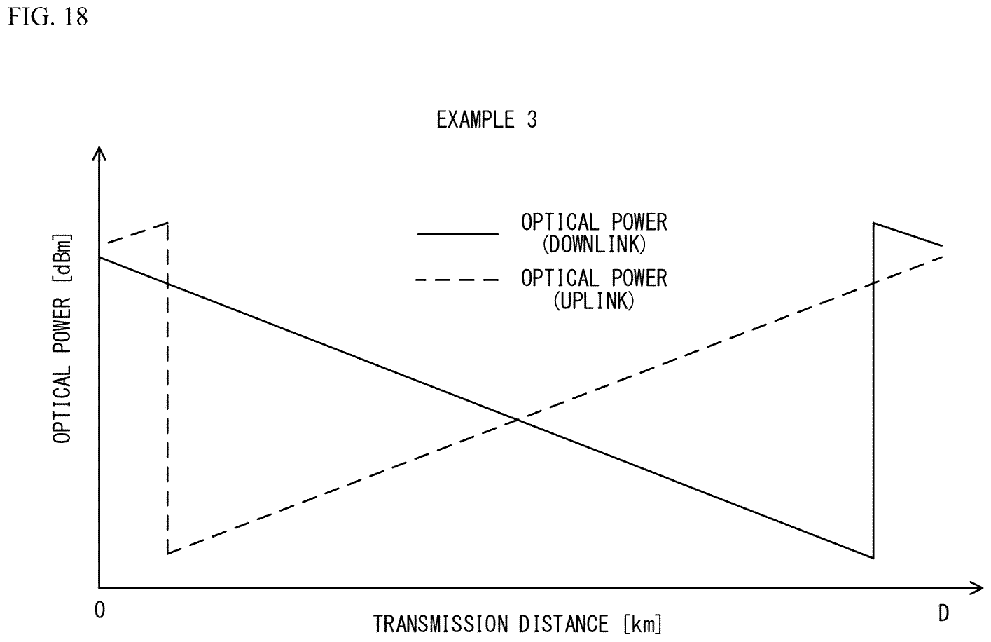

Next, an eighth embodiment of the present disclosure will be described with reference to FIGS. 17 and 18. As illustrated in FIG. 17, the optical transmission apparatus 10 according to the eighth embodiment is different from the optical transmission apparatus 10 (see FIG. 9) according to the fourth embodiment in that the optical transmission apparatus 10 according to the eighth embodiment does not include the Raman amplifier 130. Since the optical transmission apparatus 20 according to the eighth embodiment has basically the same configuration as the optical transmission apparatus 10 according to the fourth embodiment, detailed description thereof will be omitted. As described above, even if the optical transmission apparatus 10 does not include the Raman amplifier 130, the optical transmission apparatus 10 includes the optical amplifier 140, so that the signal power of the signal light 42 is increased. As a result, the crosstalk amount becomes smaller than the reference amount, and the occurrence of the OSNR penalty is suppressed.

That is, as illustrated in FIG. 18, for example, in the vicinity of the optical transmission apparatus 10, the optical power of the signal light 42 in the uplink direction and the optical power of the signal light 41 in the downlink direction are reversed, and the optical power of the signal light 42 in the uplink direction becomes relatively larger than the optical power of the signal light 41 in the downlink direction. Also in the vicinity of the optical transmission apparatus 20, the optical power of the signal light 42 in the uplink direction transmitted by the optical transmission apparatus 20 and the optical power of the signal light 41 in the downlink direction received by the optical transmission apparatus 20 are reversed as in the case of the optical transmission apparatus 10. That is, even in the vicinity of the optical transmission apparatus 20, the optical power of the signal light 41 in the downlink direction becomes relatively larger than the optical power of the signal light 42 in the uplink direction. As a result, the crosstalk amount becomes smaller than the reference amount, and the occurrence of the OSNR penalty is suppressed.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various change, substitutions, and alterations could be made hereto without departing from the spirit and scope of the invention.

What is claimed is:

1. An optical transmission apparatus that is disposed at an end of a single-core optical fiber and is used when signal light is transmitted bidirectionally by the optical fiber, the optical transmission apparatus comprising:
an optical transmitter that transmits a first signal light in one direction belonging to the signal light;
an optical receiver that receives a second signal light in an opposite direction belonging to the signal light;
an optical circulator that guides the first signal light transmitted from the optical transmitter to the optical fiber and guides the second signal light from the optical fiber to the optical receiver; and
a light source that outputs, to the optical fiber, pump light for Raman-amplifying the second signal light to a second optical power higher than a first optical power of the first signal light.

2. The optical transmission apparatus according to claim 1, further comprising
an optical amplifier that amplifies the second signal light without amplifying the first signal light.

3. The optical transmission apparatus according to claim 1, wherein
the light source includes a first light source that outputs primary pump light for Raman-amplifying the second signal light to the optical fiber, and a second light source that outputs secondary pump light for Raman-amplifying the primary pump light.

4. The optical transmission apparatus according to claim 3, wherein
the primary pump light is incoherent pump light in a first wavelength band, and the secondary pump light is coherent pump light in a second wavelength band shorter than the first wavelength band.

5. The optical transmission apparatus according to claim 1, wherein
the optical transmission apparatus is connected to another optical transmission apparatus opposite to the optical transmission apparatus via the optical fiber, and
the another optical transmission apparatus comprising:
an opposite receiver that receives the first signal light;
an opposite transmitter that transmits the second signal light;
an opposite circulator that guides the first signal light from the optical fiber to the opposite receiver and guides the second signal light transmitted from the opposite transmitter to the optical fiber; and
an opposite light source that outputs, to the optical fiber, another pump light for Raman-amplifying the first signal light received by the opposite receiver to a fourth optical power higher than a third optical power of the second signal light transmitted by the opposite transmitter.

6. The optical transmission apparatus according to claim 1, wherein
one or more optical repeaters are disposed between a first optical fiber belonging to the optical fiber and a second optical fiber belonging to the optical fiber, and
the one or more optical repeaters include another light source that outputs the pump light to each of the first optical fiber and the second optical fiber.

7. The optical transmission apparatus according to claim 6, further comprising
an optical amplifier that amplifies the second signal light without amplifying the first signal light.

8. An optical transmission apparatus used when signal light is transmitted bidirectionally by a single-core optical fiber, the optical transmission apparatus comprising:
an optical transmitter that transmits a first signal light in one direction belonging to the signal light;
an optical receiver that receives a second signal light in an opposite direction belonging to the signal light;
an optical circulator that guides the first signal light transmitted from the optical transmitter to the optical fiber and guides the second signal light from the optical fiber to the optical receiver; and
an optical amplifier that amplifies the second signal light without amplifying the first signal light.

9. The optical transmission apparatus according to claim 1, wherein
a first wavelength of the first signal light and a second wavelength of the second signal light are the same as each other.

10. The optical transmission apparatus according to claim 1, wherein
a first wavelength of the first signal light is different from a second wavelength of the second signal light.

11. The optical transmission apparatus according to claim 8, wherein
a first wavelength of the first signal light and a second wavelength of the second signal light are the same as each other.

12. The optical transmission apparatus according to claim 8, wherein
a first wavelength of the first signal light is different from a second wavelength of the second signal light.

13. An optical transmission system that transmits signal light bidirectionally by a single-core optical fiber, comprising:
an optical transmission apparatus disposed at a fiber end of the optical fiber;
wherein the optical transmission apparatus comprising:
an optical transmitter that transmits a first signal light in one direction belonging to the signal light;
an optical receiver that receives a second signal light in an opposite direction belonging to the signal light;
an optical circulator that guides the first signal light transmitted from the optical transmitter to the optical fiber and guides the second signal light from the optical fiber to the optical receiver; and
a light source that outputs, to the optical fiber, pump light for Raman-amplifying the second signal light to a second optical power higher than a first optical power of the first signal light.

14. An optical transmission method executed by an optical transmission apparatus, the optical transmission apparatus being disposed at an end of a single-core optical fiber and being used when signal light is transmitted bidirectionally by the optical fiber, the optical transmission method comprising:
transmitting a first signal light in one direction belonging to the signal light;
receiving a second signal light in an opposite direction belonging to the signal light;
guiding the first signal light transmitted from the optical transmitter to the optical fiber;
guiding the second signal light from the optical fiber to the optical receiver; and
outputting, to the optical fiber, pump light for Raman-amplifying the second signal light to a second optical power higher than a first optical power of the first signal light.
